(19) United States
(12) Patent Application Publication
(10) Pub. No.: US 2018/0117547 A1
(43) Pub. Date: May 3, 2018

(54) MIXING DEVICE, IN PARTICULAR BULK MATERIAL MIXING DEVICE

(71) Applicant: Gericke AG, Regensdorf (CH)

(72) Inventors: Markus GERICKE, Zollikon (CH); Ralf WEINEKÖTTER, Zurich (CH); Aleksandar MAKSIMOVIC, Wetzikon (CH); Christian SCHEFER, Regensdorf (CH); Reto SCHAFFNER, Weiningen (CH)

(21) Appl. No.: 15/794,185

(22) Filed: Oct. 26, 2017

(30) Foreign Application Priority Data
Oct. 28, 2016 (DE) 10 2016 120 718.7

(51) Int. Cl. B01F 7/00; B01F 7/02; B01F 13/10; B01F 15/00

(52) U.S. Cl. CPC B01F 7/00633; B01F 7/0025; B01F 7/00091; B01F 13/105; B01F 15/00538; B01F 7/024

(57) ABSTRACT

A mixing device, in particular bulk material mixing device, with at least one mixing container comprises a receiving region for receiving a material to be mixed, with at least one mixing unit which is configured for mixing the material to be mixed that is present in the mixing container, and with at least one lump breaker unit comprising at least one cutter element which protrudes into the mixing container, wherein the at least one lump breaker unit is arranged in a frontal region of the mixing container.

### STATE OF THE ART

The invention relates to a mixing device, in particular a bulk material mixing device.

A mixing device, in particular a bulk material mixing device, with at least one mixing container comprising a receiving region for receiving material to be mixed, with at least one one-sidedly supported mixing unit which is configured for mixing the material to be mixed that is present in the mixing container, and with at least one lump breaker unit comprising at least one cutter element which protrudes into the mixing container, has already been proposed.

The objective of the invention is in particular to provide a generic device having improved characteristics regarding a mixing result as well as regarding a maintenance comfort. The objective is achieved, according to the invention, by the features of patent claim 1 while advantageous implementations and further developments of the invention may be gathered from the subclaims.

### ADVANTAGES OF THE INVENTION

The invention is based on a mixing device, in particular a bulk material mixing device, with at least one mixing container comprising a receiving region for receiving a material to be mixed, with at least one mixing unit which is configured for mixing the material to be mixed that is present in the mixing container, and with at least one lump breaker unit comprising at least one cutter element which protrudes into the mixing container.

It is proposed that the at least one lump breaker unit is arranged in a frontal region of the mixing container. Preferably the lump breaker unit is arranged at least partly in an end region of the mixing container. Preferentially the cutter element protrudes into an end region of the mixing container. The mixing unit may be implemented in such a way that it is supported one-sidedly as well as in such a way that it is supported two-sidedly. Preferably at least one mixer shaft of the mixing unit is supported one-sidedly. Preferably the mixing unit is supported in an end wall, which is situated opposite the frontal region in which the lump breaker unit is arranged. A variety of mixing devices, deemed expedient by someone skilled in the art, in particular bulk material mixing devices, are conceivable, e.g. shaft mixers, like in particular dual-shaft mixers. By a “mixing container” is in particular, in this context, a container to be understood in which a mixing process of the mixing device is carried out at least partly. It is preferably to be understood, in particular, as a container comprising a receiving region for receiving a material to be mixed. The material to be mixed is received in the container in particular for a mixing process. Particularly preferably, a mixing unit, which is configured for mixing the material to be mixed, is arranged in the mixing container. The mixing container preferably has an at least substantially cylindrical basis form. Furthermore, in this context, a “mixing unit” is in particular to mean a unit which is configured for mixing the material to be mixed that is present in the mixing container. For mixing the material to be mixed, a variety of mixing units are provided which are deemed expedient by someone skilled in the art. The mixing unit preferentially comprises at least one mixer shaft, in particular at least two mixer shafts. A “mixer shaft” is herein in particular to mean a mixing element of the mixing unit, comprising at least one shaft and at least one mixing element arranged on a circumference of the shaft, in particular at least one paddle. During a mixing process the mixer shaft is in particular driven rotationally.

Furthermore, in this context, a “lump breaker unit” is in particular to mean a unit configured for comminuting clumpings occurring in the material to be mixed during operation of the mixing device. It is preferentially to mean in particular a unit with at least one cutter element, which protrudes into the mixing container and is configured to directly comminute clumpings. In particular in case of a material to be mixed that is implemented by a bulk material, clumpings may occur, e.g. due to existing humidity or introduced humidity, which are dissolvable by means of the lump breaker unit. By a “cutter element” is in particular, in this context, a tool of the lump breaker unit to be understood. The cutter element preferably comprises at least one blade, in particular rotationally driven blade, which is configured for breaking up clumpings during operation. Preferentially the cutter element comprises a plurality of blades, which are arranged offset to each other and are in particular driven rotationally. Principally, however, a different implementation of the cutter element deemed expedient by someone skilled in the art would also be conceivable. By a “frontal region” is in particular, in this context, a region of the mixing container to be understood which faces toward a front face of the mixing container. It is preferably to be understood, in particular, as a region abutting on a front-side interior wall of the mixing container. It is preferentially to be understood, in particular, viewed along a mixer shaft of the mixing unit, as an end region of the receiving region of the mixing container. The receiving region of the mixing container preferably comprises a middle region as well as two frontal regions arranged on opposite sides of the middle region. The regions are herein respectively separated from one another by imaginary planes extending perpendicularly to a rotary axis of the mixer shaft of the mixing unit. Preferably the frontal regions each take up maximally 30%, preferentially maximally 20% and especially preferentially no more than 10% of a volume of the receiving region of the mixing container. Particularly preferably the mixing container has a substantially cylindrical basis shape, at the bottom side of which the frontal region is arranged. “Configured” is in particular to mean specifically designed and/or equipped. By an object being configured for a certain function is in particular to be understood that the object fulfills and/or executes said certain function in at least one application state and/or operating state.

By an implementation of the mixing device according to the invention, in particular an advantageous arrangement of the lump breaker unit is achievable. In particular, an arrangement is achievable in which the mixing unit may be implemented of advantageously large dimensions and is only to a small extent encumbered by the lump breaker unit. In particular, a central recess in the mixing unit may be dispensed with. This allows achieving an advantageously homogeneous mixing result. Preferably furthermore a high degree of accessability of the lump breaker unit is achievable. This allows achieving an advantageously high maintenance comfort.

It is further proposed that the at least one mixing unit is supported one-sidedly. Preferably the mixing unit is supported one-sidedly on a side that is situated opposite the frontal region, in which the lump breaker unit is arranged. “Supported one-sidedly” is in particular to mean, in this context, that merely one side of the mixing unit is held via a bearing. Preferentially it is in particular to mean that only one end of a shaft, in particular of a mixer shaft, is borne. In this way in particular an arrangement is achievable in which the mixing unit may be implemented of advantageously large dimensions and is only to a small extent encumbered by the lump breaker unit. This allows achieving an advantageously high maintenance comfort.

Moreover it is proposed that the at least one lump breaker unit is arranged in an end wall of the mixing container. By an “end wall” is in particular, in this context, a wall of the mixing container to be understood which delimits a frontal region of the receiving region. Preferentially it is in particular to mean an outer wall of the mixing container, which forms a bottom side of the mixing container that differs from an encompassing surface. Depending on an orientation of the mixing container, the end wall may be oriented vertically as well as horizontally. The end wall preferably extends substantially vertically. An end wall is preferably to be understood as a wall of the mixing container that differs from a lateral wall. Especially preferentially the mixing container comprises two end walls and a circumferential lateral wall wherein, in case of a horizontal orientation of the mixing container, the lateral wall may form two sides as well as a top and/or a bottom of the receiving region of the mixing container. Preferably an end wall is in particular to mean a wall of the mixing container which is intersected by a rotary axis of the mixing unit, in particular by a mixer shaft of the mixing unit. This in particular allows achieving an especially advantageous arrangement of the lump breaker unit. In particular, an arrangement of the lump breaker unit at an end of the receiving region of the mixing container is achievable. This allows advantageously reliably and easily avoiding a collision between the mixing unit and the lump breaker unit. In particular, a collision between the mixing unit and the lump breaker unit is avoidable also in case of pulling out the mixing unit.

It is also proposed that the at least one mixing unit comprises at least one mixer shaft. Preferably the mixer shaft extends substantially in parallel to a main extension direction of the mixing container. Preferentially a rotary axis of the mixer shaft extends substantially in parallel to a main extension direction of the mixing container. Especially preferably a rotary axis of the mixer shaft extends substantially in parallel to a middle axis of the substantially cylindrical mixing container. By “at least substantially in parallel” is in particular, in this context, to be understood that an angle deviation from a parallel arrangement amounts to less than 30°, preferably to less than 15° and particularly preferably less than 5°. By a “main extension direction” of an object is herein in particular a direction to be understood that extends in parallel to a longest edge of a smallest geometric rectangular cuboid which encompasses the object just still completely. This in particular allows providing an advantageous mixing device. Preferably in particular a mixing device may be provided by means of which in particular an advantageous mixing result is achievable.

Beyond this it is proposed that a rotary axis of the cutter element of the at least one lump breaker unit extends at least substantially in parallel to a rotary axis of the at least one mixer shaft of the mixing unit. Preferably a rotary axis of the cutter element extends during operation in parallel to the rotary axis of the mixer shaft of the mixing unit. The rotary axis of the cutter element and the rotary axis of the mixer shaft of the mixing unit are preferably arranged offset with respect to one another. This in particular allows achieving an especially advantageous arrangement of the lump breaker unit. A collision between the mixing unit and the lump breaker unit is advantageously reliably and easily avoidable. In particular, a collision between the mixing unit and the lump breaker unit is avoidable also in case of pulling out the mixing unit.

It is also proposed that the mixing container comprises, in a region of an end wall, a pivot door, in which the at least one lump breaker unit is arranged. Preferably the pivot door is arranged in the end wall. Preferentially the end wall of the mixing container is at least substantially completely implemented by the pivot door. The pivot door in particular serves to make the receiving region of the mixing container accessible. This may, for example, serve for maintenance and/or cleaning purposes. Preferably, when the pivot door is opened, the lump breaker unit, in particular the cutter element of the lump breaker unit, is pivoted out of the receiving region of the mixing container. This in particular allows making the lump breaker unit accessible in an advantageously simple fashion. In this way maintenance work may be carried out advantageously easily. An advantageously high maintenance comfort is achievable.

Furthermore it is proposed that the at least one mixing unit comprises at least two mixer shafts extending substantially in parallel to each other. Preferably the mixer shafts extend completely in parallel to each other. Preferentially the mixing device is implemented as a dual-shaft mixer, in particular of a horizontally positioned dual-shaft mixer. Preferably a rotary axis of the cutter element extends during operation in parallel to the rotary axes of the mixer shafts of the mixing unit. In this way, in particular an advantageous mixing device may be rendered available. In particular, an advantageously homogeneous mixing result is achievable.

It is moreover proposed that the at least one cutter element of the lump breaker unit is arranged at least partly between the at least two mixer shafts of the at least one mixing unit. This is preferentially to mean, in particular, that at least when viewed two-dimensionally, in a plane that is perpendicular to the rotary axes of the mixer shafts, at least a partial region of the cutter element of the lump breaker unit is arranged between the at least two mixer shafts of the at least one mixing unit. It is preferably to mean in particular that, at least when viewed two-dimensionally, in a plane that is perpendicular to the rotary axes of the mixer shafts, there is at least one connecting line between a point of a first mixer shaft and a point of a second mixer shaft intersecting with the cutter element of the lump breaker unit. This in particular allows achieving an advantageous arrangement of the lump breaker unit. In particular, an arrangement is achievable allowing an implementation of the mixing unit in advantageously large dimensions. Preferably, in particular an arrangement is achievable allowing both mixer shafts conveying material to be mixed to the lump breaker unit. In this way an advantageously homogeneous mixing result is achievable.

It is further proposed that the at least one cutter element of the lump breaker unit intersects with a rotary axis of the mixer shaft of the at least one mixing unit. Preferably the at least one cutter element of the lump breaker unit intersects with a rotary axis of the mixer shaft of the at least one mixing unit in at least one operating state, in particular in at least one rotational position of the cutter element. The mixer shaft preferably comprises a recess in a region of the cutter element, allowing the cutter element intersecting with the rotary axis of the mixer shaft of the at least one mixing unit. Especially preferentially one mixer shaft of the mixing unit is shortened and does not protrude up to the end wall of the mixing container. A rotary axis of the at least one cutter element of the lump breaker unit is preferentially offset to the rotary axis of the mixer shaft, wherein the cutters of the cutter element intersect with the rotary axis of the mixer shaft in at least one operating state, in particular in at least one rotational position. In this way in particular an advantageous arrangement of the lump breaker unit is achievable. In particular, an advantageously compact arrangement is achievable.

Beyond this it is proposed that the receiving region of the at least one mixing container comprises at least one bulge which is located outside a mixing zone of the at least one mixer shaft and into which the at least one cutter element of the lump breaker unit protrudes. By a “mixing zone” is in particular, in this context, a zone, preferably a circular-cylindrical zone, of the receiving region to be understood, in which a direct mixing is carried out by the mixer shaft. Preferentially the mixing zone defines a range of the mixer shaft, in particular a range of the paddles of the mixer shaft. The bulge is preferably partly arranged between a mixing zone of a first mixer shaft and a mixing zone of a second mixer shaft. This in particular allows achieving a particularly advantageous arrangement of the lump breaker unit. In this way in particular an advantageous arrangement of the lump breaker unit is achievable without reducing a size of the mixing zone. It is thus possible to avoid the lump breaker unit protruding into an actual mixing zone of the at least one mixer shaft.

It is also proposed that, viewed in a plane that is perpendicular to a rotary axis of the at least one cutter element, the at least one cutter element of the lump breaker unit comprises a cutter impact surface, the area value of which amounts to at least 2% of an area value of a wall surface of an end wall of the mixing container. A percentage of the cutter impact surface with respect to the wall surface preferably amounts to at least 2%. Preferentially the at least one cutter element of the lump breaker unit is arranged in the end wall of the mixing container. An area value of the cutter impact surface is at least 3%, preferably at least 5% and especially preferentially at least 10% of an area value of the wall surface of the end wall. Particularly preferably, however, the area value of the cutter impact surface is maximally 35%, preferably no more than 30% and particularly preferably no more than 25% of the area value of the wall surface of the end wall. In particular in a small mixing device, the area value of the cutter impact surface preferably amounts to approximately 13% of the wall surface of the end wall. In a large mixing device the area value of the cutter impact surface preferably amounts to approximately 2% of the area value of the wall surface of the end wall. In case of two cutter elements being used in a small mixing device, the area value of the cutter impact surface preferably amounts to approximately 26% of the area value of the wall surface of the end wall, while in a large mixing device with two cutter elements the area value of the cutter impact surface preferably amounts to approximately 7% of the area value of the wall surface of the end wall. By a “cutter impact surface” is in particular, in this context, an imaginary area to be understood which, viewed in a plane that is perpendicular to a rotary axis of the at least one cutter element, is swept over by the cutter element during operation of the lump breaker unit. The area is preferably implemented by a circle area, the radius of which is equivalent to a radius of the cutter element. Preferentially the cutter impact surface extends in parallel to a main extension plane of the cutter element. By a “main extension plane” of a structural unit is in particular a plane to be understood which is parallel to a largest lateral surface of a smallest imaginary rectangular cuboid just still completely encompassing the structural unit, and which in particular extends through the center of the rectangular cuboid. By a “wall surface” is in particular, in this context, a surface of the end wall to be understood which faces towards the receiving region of the mixing container. This in particular allows rendering an advantageously efficient lump breaker unit available. An advantageously homogeneous mixing result is achievable. In particular, due to the arrangement of the lump breaker unit an advantageously large dimensioning of the at least one cutter element of the lump breaker unit is achievable.

The invention is furthermore based on a method for operating a mixing device. It is proposed that in at least one first method step material to be mixed is transported to a cutter element of at least one lump breaker unit of the mixing device by means of a mixer shaft of a mixing unit of the mixing device. Preferably, for this purpose the paddles of the mixer shaft are adjusted in such a way that a material to be mixed, which is located in the mixing zone of the mixer shaft, is transported to the cutter element of the at least one lump breaker unit of the mixing device via the paddles. In this way it is reliably achievable that clumpings in the material to be mixed are reliably destroyed by the lump breaker unit.

It is also proposed that in at least one further method step a material to be mixed is transported away from the cutter element of the at least one lump breaker unit by means of a mixer shaft of the mixing unit of the mixing device. Preferably, for this purpose, paddles of the mixer shaft are adjusted in such a way that a material to be mixed, which is conveyed into the mixing zone of the mixer shaft by the cutter element of the at least one lump breaker unit, is transported away from the cutter element of the at least one lump breaker unit by means of the paddles. In this way it is reliably achievable that clumpings in the material to be mixed are reliably destroyed by the lump breaker unit and an advantageous circulation of the material to be mixed in the mixing container is achieved.

The mixing device according to the invention and the method are herein not to be restricted to the application and implementation form described above. In particular, the mixing device according to the invention as well as the method may, to implement a functionality herein described, comprise a number of respective elements, structural components and units that differs from a number herein mentioned.

### DRAWINGS

Further advantages will become apparent from the following description of the drawings. In the drawings five exemplary embodiments of the invention are shown. The drawings, the description and the claims contain a plurality of features in combination. Someone skilled in the art will purposefully also consider the features separately and will find further expedient combinations.

It is shown in:

FIG. 1 a mixing device according to the invention, with a mixing container, with a one-sidedly supported mixing unit and with a lump breaker unit, in a schematic presentation, in an operating state,

FIG. 2 the mixing device according to the invention, with the mixing container, with the one-sidedly supported mixing unit and with the lump breaker unit, in a schematic presentation, in an opened state,

FIG. 3 the mixing device according to the invention, with the mixing container, with the one-sidedly supported mixing unit and with the lump breaker unit comprising a cutter element, in a schematic sectional view along the section line III-III,

FIG. 4 the mixing device according to the invention, with the mixing container, with the one-sidedly supported mixing unit and with the lump breaker unit comprising the cutter element, in a schematic sectional view along the section line IV-IV,

FIG. 5 a schematic flow chart of a method for operating the mixing device,

FIG. 6 an alternative mixing device according to the invention, with a mixing container, with a one-sidedly supported mixing unit and with a lump breaker unit, in a schematic sectional view perpendicularly to a rotary axis of the mixing unit,

FIG. 7 a further alternative mixing device according to the invention, with a mixing container, with a two-sidedly supported mixing unit and with a lump breaker unit, in a schematic sectional view in parallel to a rotary axis of the mixing unit,

FIG. 8 another alternative mixing device according to the invention, with a mixing container, with a mixing unit and with a lump breaker unit, in a schematic presentation, in an operating state, and

FIG. 9 a further alternative mixing device according to the invention, with a mixing container, with a two-sidedly supported mixing unit and with a lump breaker unit, in a schematic sectional view in parallel to a rotary axis of the mixing unit.

### DESCRIPTION OF THE EXEMPLARY EMBODIMENTS

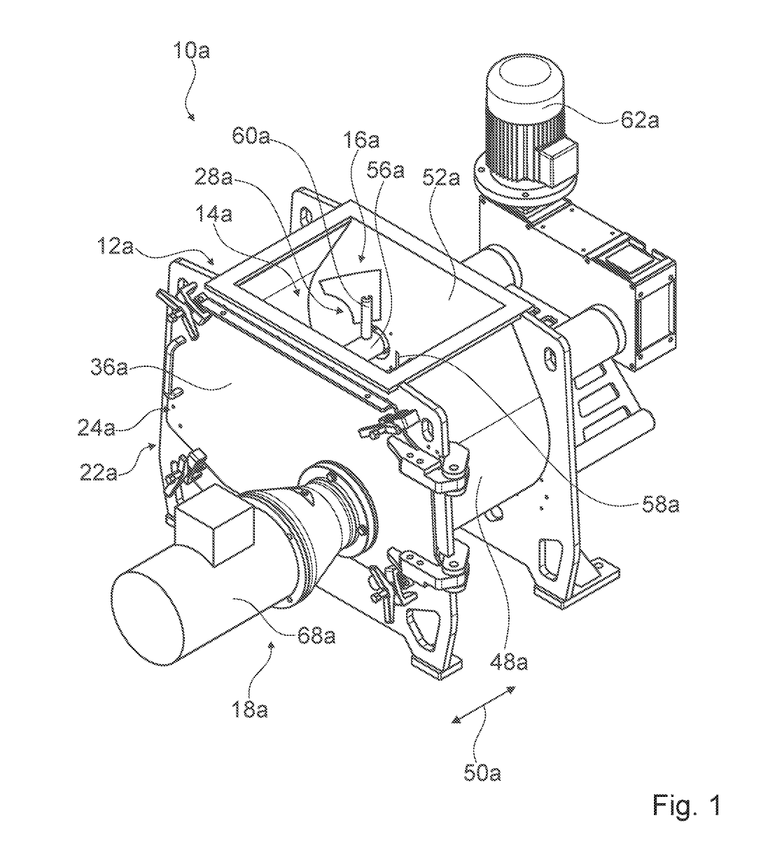

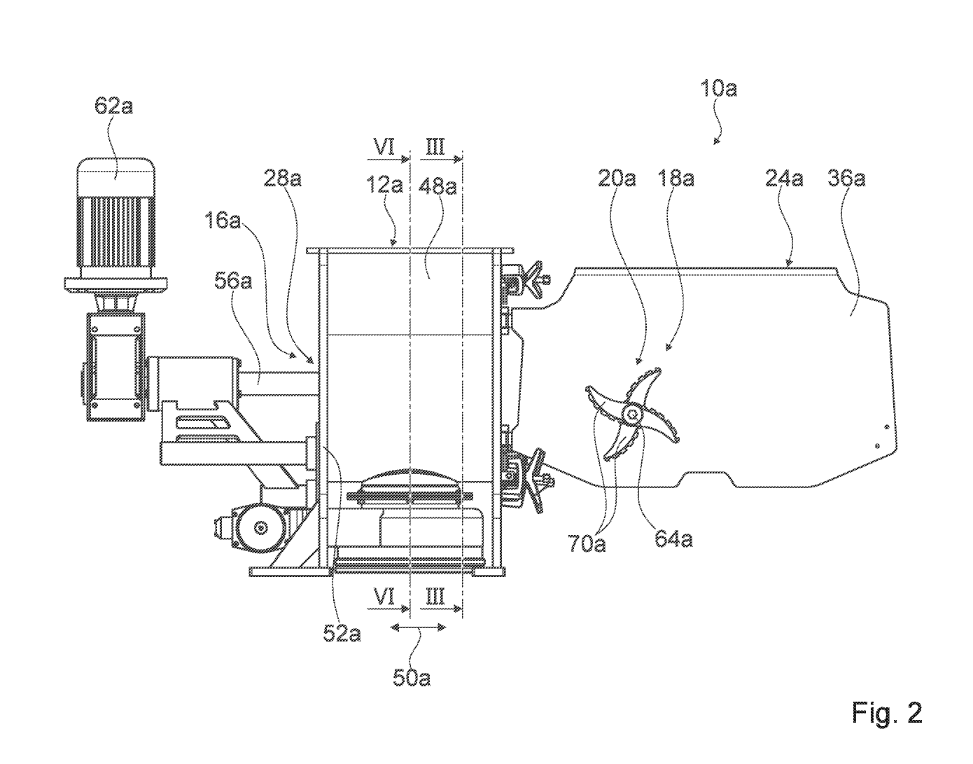

FIGS. 1 and 2 show a mixing device 10a. The mixing device 10a is implemented by a bulk material mixing device. The mixing device 10a is implemented by a bulk material batch mixing device. The mixing device 10a is embodied by a two-shaft mixer. The mixing device 10a is embodied as a horizontally positioned dual-shaft mixer. Preferably the mixing device 10a may be configured for batch mixing processes as well as for continuous mixing processes. Principally however a different implementation of the mixing device 10a, deemed expedient by someone skilled in the art, would also be conceivable. A structure could principally also be applied for a single-shaft mixer correspondingly. By means of the mixing device 10a, by incidental particle exchange, in particular dispersion, and by selective dividing-up and mingling, in particular convection, a homogeneous mixing of different materials to be mixed is achieved. The mixing device 10a is configured for mixing solid matters as well as mixing solid matters with liquids. Principally however a different usage deemed expedient by someone skilled in the art would also be conceivable.

The mixing device 10a comprises a mixing container 12a. The mixing container 12a has a cylindrical basis shape. A main extension direction 50a of the mixing container 12a extends substantially horizontally during operation. The mixing container 12a therefore has a horizontally cylindrical basis shape. Furthermore the mixing container 12a implements a housing of the mixing device 10a. The mixing container 12a comprises an outer sleeve 48a. The outer sleeve 48a comprises a plurality of feet supporting the mixing container 12a. The mixing container 12a is preferably mounted on a rack (not shown in detail) via the feet of the outer sleeve 48a. The outer sleeve 48a is substantially made of metal. Principally however a different material implementation, deemed expedient by someone skilled in the art, would also be conceivable. The mixing container 12a further comprises a receiving region 14a for receiving a material to be mixed. The receiving region 14a has a cylindrical shape. Along a middle axis, viewed in a plane that is perpendicular to the middle axis, the receiving region 14a features a constant cross section. The middle axis of the receiving region 14a extends in parallel to the main extension direction 50a of the mixing container 12a. The receiving region 14a is partially delimited by the outer sleeve 48a of the mixing container 12a. The receiving region 14a is on an encompassing surface delimited by the outer sleeve 48a of the mixing container 12a. Furthermore the mixing container 12a comprises two end walls 24a, 52a. The end walls 24a, 52a close the mixing container 12a on two opposite ends of the outer sleeve 48a. The end walls 24a, 52a delimit the receiving region 14a on opposite ends along the middle axis of the receiving region 14a. The end walls 24a, 52a respectively extend in a plane that is perpendicular to the middle axis of the receiving region 14a. The mixing container 12a comprises, in the region of an end wall 24a, a pivot door 36a. The pivot door 36a is arranged in the end wall 24a. The end wall 24a of the mixing container 12a is substantially completely embodied by the pivot door 36a. The pivot door 36a serves in particular for making the receiving region 14a of the mixing container 12a accessible. The pivot door 36a is embodied by a front door. FIG. 2 shows the pivot door 36a in an opened state.

Furthermore the mixing device 10a comprises a mixing unit 16a, which is supported in a one-sided manner. The one-sidedly supported mixing unit 16a is configured for mixing the material to be mixed that is present in the mixing container 12a. The mixing unit 16a is one-sidedly supported in an end wall 52a of the mixing container 12a. The mixing unit 16a is embodied by a shaft-mixing unit. The one-sidedly supported mixing unit 16a comprises at least one mixer shaft 26a, 28a. The one-sidedly supported mixing unit 16a comprises two mixer shafts 26a, 28a. The mixer shafts 26a, 28a extend substantially in parallel to one another. The mixer shafts 26a, 28a of the mixing unit 16a comprise rotary axes 32a, 34a, which extend in parallel. The rotary axes 32a, 34a of the mixer shafts 26a, 28a respectively extend in parallel to the main extension direction 50a of the mixing container 12a. The mixer shafts 26a, 28a are each supported in a one-sided manner. The mixer shafts 26a, 28a are embodied by one-sidedly supported free-running mixing tools. The mixer shafts 26a, 28a are each supported in the end wall 52a of the mixing container 12a. For this purpose, a bearing for the mixer shafts 26a, 28a is arranged in the end wall 52a. The mixer shafts 26a, 28a are each configured of a shaft 54a, 56a as well as of a plurality of mixing elements 58a, 60a arranged on a circumference of the shaft 54a, 56a. The shafts 54a, 56a of the mixer shafts 26a, 28a are each embodied by a circle-cylindrical full shaft. Principally however a different implementation of the shafts 54a, 56a, deemed expedient by someone skilled in the art, would also be conceivable, e.g. as a hollow shaft. In case of an implementation of the shaft 54a, 56a as a hollow shaft, it would principally be conceivable that fluids, in particular liquids, could be introduced via a hollow space of the shaft 54a, 56a. In particular, liquids could be introduced into the receiving region 14a via the shaft. The mixing elements 58a, 60a are respectively embodied by paddles. Principally however a different implementation of the mixing elements 58a, 60a, deemed expedient by someone skilled in the art, would also be conceivable. During operation the mixer shafts 26a, 28a are arranged substantially in the receiving region 14a of the mixing container 12a. The mixer shafts 26a, 28a protrude into the receiving region 14a. The mixer shafts 26a, 28a define in the receiving region 14a respectively one circle-cylindrical mixing zone, in which a direct mixing is carried out by the respective mixer shaft 26a, 28a. The shafts 54a, 56a of the mixer shafts 26a, 28a protrude at one end through the end wall 52a out of the receiving region 14a, and are in the receiving region 14a driven by a drive unit 62a. The drive unit 62a drives the two mixer shafts 26a, 28a via a gearing, which is not shown. The drive unit 62a drives the two mixer shafts 26a, 28a rotationally. The drive unit 62a is embodied by a motor. The drive unit 62a is embodied by an electromotor. The mixing unit 16a is embodied in such a way that it is completely deployable out of the mixing container 12a. Deployment is effected via a deployment carriage (not shown in detail), on which the mixing unit 16a is mounted and which is guided on extension rails (not shown in detail). In a deployment, the drive unit 62a and the end wall 52a are moved as well. By a deployment of the mixing unit 16a, the mixer shafts 26a, 28a may be pulled out of the mixer easily and completely. In this way, the whole mixing container 12a is advantageously accessible for cleaning.

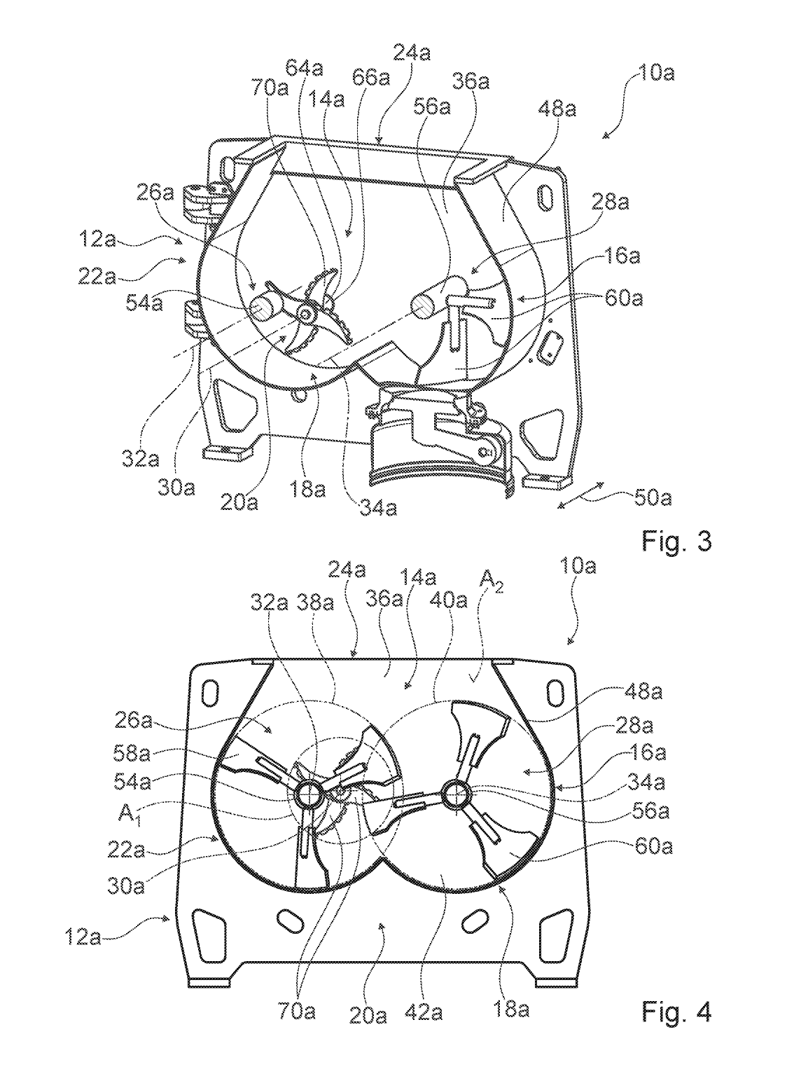

The mixing device 10a moreover comprises a lump breaker unit 18a. The lump breaker unit 18a is configured for comminuting clumpings that have occurred in the material to be mixed during operation of the mixing device 10a. The lump breaker unit 18a is arranged in a frontal region 22a of the mixing container 12a. The lump breaker unit 18a is arranged on a side of the receiving region 14a that is situated opposite the bearing point of the mixing unit 16a, in a frontal region 22a of the mixing container 12a. The lump breaker unit 18a is arranged in an end region of the mixing container 12a. The lump breaker unit 18a is arranged in the end wall 24a of the mixing container 12a. The lump breaker unit 18a is arranged in the end wall 24a of the mixing container 12a, which is situated opposite the end wall 52a, which the mixing unit 16a is supported in. The end wall 24a is arranged on a bottom side of the cylindrical mixing container 12a. The lump breaker unit 18a is arranged in the pivot door 36a of the mixing container 12a. The lump breaker unit 18a is arranged in the pivot door 36a of the end wall 24a of the mixing container 12a. Via the pivot door 36a, the lump breaker unit 18a is pivotable out of the receiving region 14a of the mixing container 12a. When the pivot door 36a is opened, the lump breaker unit 18a is pivoted as well (FIG. 2). The lump breaker unit 18a comprises a cutter element 20a, which protrudes into the mixing container 12a. Principally it would also be conceivable that the lump breaker unit 18a comprises a plurality of cutter elements 20a which are, for example, arranged side by side. The cutter element 20a protrudes into the mixing container 12a for a direct comminution of clumpings. The cutter element 20a implements a tool of the lump breaker unit 18a. The cutter element 20a comprises a shaft 64a, which protrudes through the pivot door 36a of the end wall 24a. In the pivot door 36a a bearing 66a for the shaft 64a is accommodated. On an outer side of the pivot door 36a, a drive unit 68a of the lump breaker unit 18a is arranged, which is configured for driving the cutter element 20a during operation. The drive unit 68a drives the shaft 64a of the cutter element 20a rotationally. The cutter element 20a further comprises a plurality of blades 70a. The cutter element 20a comprises two blades 70a. The blades 70a are each implemented by a double-blade implementing respectively one cutting edge on both sides of a rotary axis. Principally however a different number and/or implementation of the blades 70a, deemed expedient by someone skilled in the art, would also be conceivable. The blades 70a are respectively arranged on a free side of the shaft 64a, which faces away from the drive unit 68a. The blades 70a are each arranged on an end of the shaft 64a, which protrudes into the receiving region 14a. The blades 70a are arranged offset to each other by 90°. Principally however a different implementation of the cutter element 20a, deemed expedient by someone skilled in the art, would also be conceivable. The cutter element 20a is supported in a one-sided manner. The cutter element 20a is supported on a side of the receiving region 14a that is situated opposite the bearing point of the mixer shafts 26a, 28a of the mixing unit 16a (FIGS. 1 and 3).

A rotary axis 30a of the cutter element 20a of the lump breaker unit 18a extends substantially in parallel to the rotary axes 32a, 34a of the mixer shafts 26a, 28a of the one-sidedly supported mixing unit 16a. The rotary axis 30a of the cutter element 20a of the lump breaker unit 18a is arranged offset to the rotary axes 32a, 34a of the mixer shafts 26a, 28a. Furthermore the cutter element 20a of the lump breaker unit 18a is partially arranged between the two mixer shafts 26a, 28a of the mixing unit 16a. The cutter element 20a is arranged, at least with a partial region, viewed in a plane that is perpendicular to the rotary axes 32a, 34a of the mixer shafts 26a, 28a, between the at least two mixer shafts 26a, 28a. The cutter element 20a of the lump breaker unit 18a furthermore intersects with a rotary axis 32a of the first mixer shaft 26a of the mixing unit 16a. During operation the cutter element 20a of the lump breaker unit 18a intersects with the rotary axis 32a of the first mixer shaft 26a of the mixing unit 16a in at least one rotational position of the cutter element 20a. The rotary axis 30a of the cutter element 20a of the lump breaker unit 18a is offset to the rotary axis 32a of the first mixer shaft 26a wherein, during operation, the blades 70a of the cutter element 20a intersect with the rotary axis 32a of the first mixer shaft 26a depending on a rotational position. The first mixer shaft 26a comprises a recess in a region of the cutter element 20a, allowing the cutter element 20a intersecting with the rotary axis 32a of the first mixer shaft 26a of the mixing unit 16a. The first mixer shaft 26a of the mixing unit 16a is shortened and does not protrude up to the end wall 24a of the mixing container 12a, which the lump breaker unit 18a is arranged in. The first mixer shaft 26a of the mixing unit 16a is shortened with respect to the second mixer shaft 28a. The cutter element 20a is arranged at least partly below an imaginary plane extending through the rotary axes 32a, 34a of the mixer shafts 26a, 28a. The rotary axis 30a of the cutter element 20a is arranged below an imaginary plane extending through the rotary axes 32a, 34a of the mixer shafts 26a, 28a (FIG. 3).

The cutter element 20a of the lump breaker unit 18a comprises, viewed in a plane that is perpendicular to the rotary axis 30a of the cutter element 20a, a cutter impact surface A₁. The cutter impact surface A₁ extends in parallel to a main extension plane of the cutter element 20a. Furthermore the cutter impact surface A₁ extends in parallel to a main extension plane of the end wall 24a of the mixing container 12a. The cutter impact surface

A₁ is implemented by a circle area, the radius of which is equivalent to a radius of the cutter element 20a. An area value of the cutter impact surface A₁ is at least 2% of an area value of a wall surface A₂ of the end wall 24a of the mixing container 12a. The area value of the cutter impact surface A₁ is approximately 4% of the area value of the wall surface A₂ of the end wall 24a of the mixing container 12a. Principally however a different area ratio that is deemed expedient by someone skilled in the art would also be conceivable. The wall surface A₂ of the end wall 24a extends in parallel to a main extension plane of the end wall 24a. The wall surface A₂ is arranged on a side of the end wall 24a that faces towards the receiving region 14a of the mixing container 12a (FIG. 4).

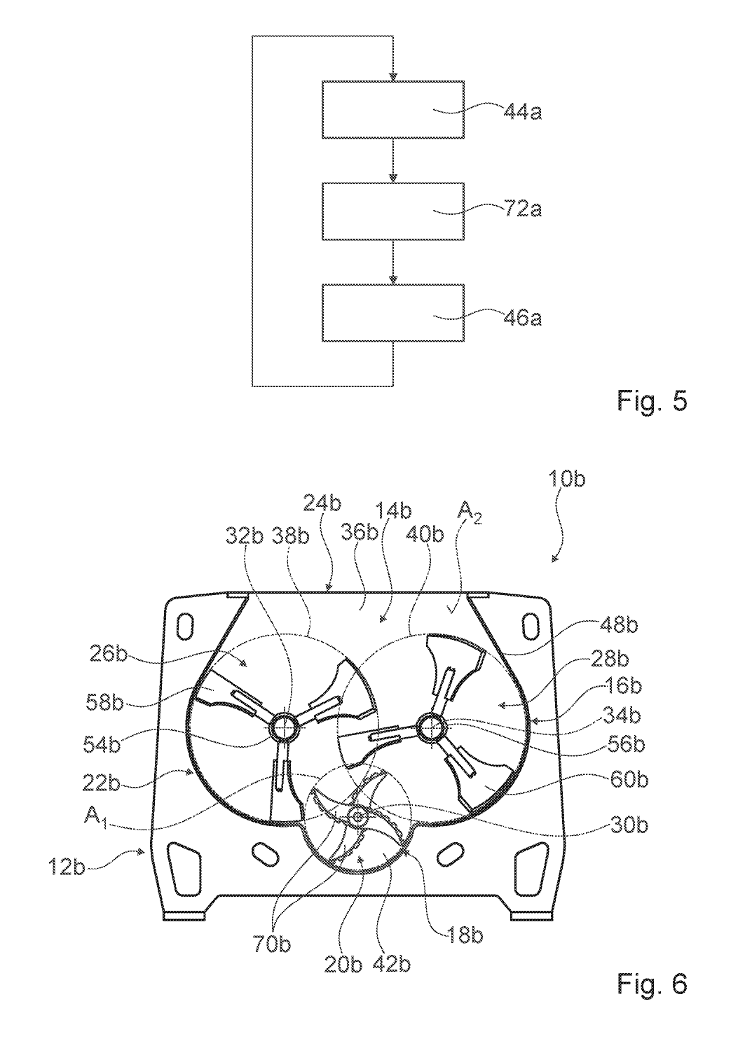

FIG. 5 shows a flow chart of a method for operating the mixing device 10a. FIG. 5 shows a flow chart of a mixing method. During the method a mixing of a material to be mixed, which is fed to the mixing device 10a, is carried out. A mixing of solid matters as well as a mixing of solid matters with liquids is carried out. For this purpose a liquid input is effected during a method (not shown in detail). For this purpose, for example, liquid is sprayed into the receiving region 14a by a nozzle or by a plurality of nozzles. Furthermore, during the method, in a first method step 44a, a material to be mixed is transported to the cutter element 20a of the lump breaker unit 18a of the mixing device 10a by means of the first mixer shaft 26a of the mixing unit 16a of the mixing device 10a. The mixing elements 58a of the first mixer shaft 26a, which are embodied as paddles, are for this purpose oriented in such a way that a material to be mixed that is present in the mixing zone of the first mixer shaft 26a is transported to the cutter element 20a of the lump breaker unit 18a of the mixing device 10a by means of the mixing elements 58a. The material to be mixed is herein transported towards the cutter element 20a along the rotary axis 32a of the first mixer shaft 26a. Then, in a second method step 72a, clumpings in the material to be mixed are destroyed by means of the cutter element 20a of the lump breaker unit 18a. The material to be mixed is moreover partly conveyed, in particular hurled, into the mixing zone of the second mixer shaft 28a by the cutter element 20a. Following this, in a further method step 46a, material to be mixed is transported away from the cutter element 20a of the lump breaker unit 18a by means of the second mixer shaft 28a of the mixing unit 16a of the mixing device 10a. The mixing elements 60a of the second mixer shaft 28a, which are embodied as paddles, are for this purpose oriented in such a way that a mixing material conveyed into the mixing zone of the second mixer shaft 28a by the cutter element 20a of the lump breaker unit 18a is transported away from the cutter element 20a of the lump breaker unit 18a by the mixing elements 60a. The material to be mixed is herein transported away from the cutter element 20a along the rotary axis 34a of the second mixer shaft 28a. Then the first method step 44a is repeated. The material to be mixed is hence partly conveyed through the mixing container 12a cyclically.

In FIGS. 6 to 9 four further exemplary embodiments of the invention are shown. The following descriptions are substantially limited to the differences between the exemplary embodiments, wherein regarding structural components, features and functions that remain the same, the description of the other exemplary embodiments, in particular of FIGS. 1 to 5, may be referred to. For distinguishing between the exemplary embodiments, the letter a in the reference numerals of FIGS. 1 to 5 has been replaced by the letters b to e in the reference numerals of the exemplary embodiments of FIGS. 6 to 9. As regards structural components with the same denomination, in particular structural components having the same reference numerals, principally the drawings and/or description of the other exemplary embodiments, in particular of FIGS. 1 to 5, may also be referred to.

FIG. 6 shows a mixing device 10b with a mixing container 12b, with a one-sidedly supported mixing unit 16b and with a lump breaker unit 18b. The one-sidedly supported mixing unit 16b is configured for mixing the material to be mixed that is present in the mixing container 12b. The mixing unit 16b is embodied by a shaft-mixing unit. The one-sidedly supported mixing unit 16b comprises two mixer shafts 26b, 28b. The mixer shafts 26b, 28b extend substantially in parallel to one another. The two mixer shafts 26b, 28b of the mixing unit 16b comprise rotary axes 32b, 34b running in parallel. The mixer shafts 26b, 28b each respectively define, in a receiving region 14b of the mixing container 12b, a circle-cylindrical mixing zone 38b, 40b in which a direct mixing is effected by the respective mixer shaft 26b, 28b. The mixer shafts 26b, 28b protrude along a main extension direction of the mixing container 12b through the entire receiving region 14b. The mixer shafts 26b, 28b protrude with a free end up to shortly before an end wall 24b of the mixing container 12b.

The mixing container 12b furthermore comprises the receiving region 14b for receiving a material to be mixed. The receiving region 14b has a substantially cylindrical shape. The receiving region 14b of the mixing container 12b comprises a bulge 42b that is situated outside the mixing zones 38b, 40b of the mixer shafts 26b, 28b. The bulge 42b is implemented by a circle-portion cylindrical bulge. The bulge 42b is only configured in a frontal region 22b of the mixing container 12b. Principally however it would also be conceivable that the bulge 42b could extend over a full length of the mixing container 12b. The bulge 42b abuts on an end wall 24b of the mixing container 12b. The bulge 42b is arranged below the rotary axes 32b, 34b of the mixer shafts 26b, 28b.

During operation of the mixing device 10b, the lump breaker unit 18b is also configured for a comminution of clumpings that have occurred in the material to be mixed. The lump breaker unit 18b is arranged in a frontal region 22b of the mixing container 12b. The lump breaker unit 18b is arranged, on a side of the receiving region 14b that is situated opposite a bearing point of the mixing unit 16b, in a frontal region 22b of the mixing container 12b. The lump breaker unit 18b is arranged in the end wall 24b of the mixing container 12b. The lump breaker unit 18b is arranged in a pivot door 36b of the end wall 24b of the mixing container 12b. The lump breaker unit 18b comprises a cutter element 20b protruding into the mixing container 12b. A rotary axis 30b of the cutter element 20b of the lump breaker unit 18b extends substantially in parallel to the rotary axes 32b, 34b of the mixer shafts 26b, 28b of the one-sidedly supported mixing unit 16b. The rotary axis 30b of the cutter element 20b of the lump breaker unit 18b is arranged offset to the rotary axes 32b, 34b of the mixer shafts 26b, 28b. Furthermore the cutter element 20b of the lump breaker unit 18b is partially arranged between the two mixer shafts 26b, 28b of the mixing unit 16b. The cutter element 20b is arranged substantially outside the mixing zones 38b, 40b of the mixer shafts 26b, 28b. The cutter element 20b is arranged substantially within the bulge 42b. The cutter element 20b of the lump breaker unit 18b protrudes into the bulge 42b.

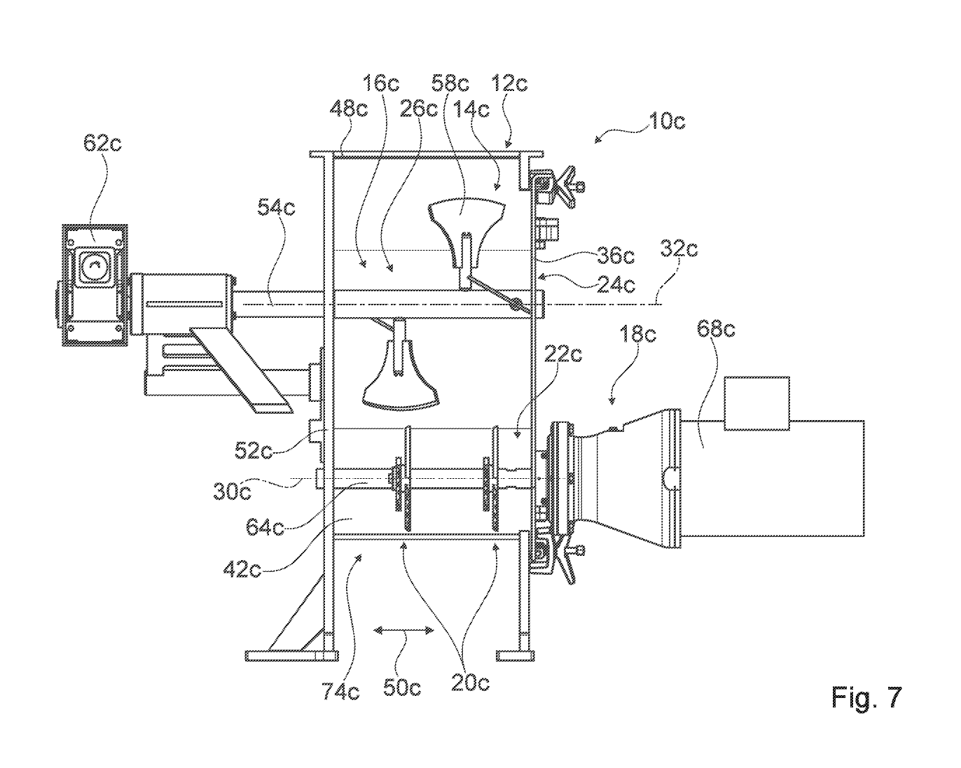

FIG. 7 shows a mixing device 10c with a mixing container 12c, with a two-sidedly supported mixing unit 16c and with a lump breaker unit 18c. The two-sidedly supported mixing unit 16c is configured for mixing the material to be mixed that is present in the mixing container 12c. The mixing unit 16c is implemented by a shaft-mixing unit. The mixing unit 16c comprises two mixer shafts 26c. It would however principally also be conceivable that the mixing unit 16c comprises only one mixer shaft 26c. A construction may principally also be applied to a single-shaft mixer correspondingly. The mixer shafts 26c extend substantially in parallel to one another. The two mixer shafts 26c of the mixing unit 16c have rotary axes 32c, 34c extending in parallel. The mixer shafts 26c protrude through the entire receiving region 14c along a main extension direction of the mixing container 12c. The mixer shafts 26c are each supported on both ends.

Beyond this, the mixing container 12c comprises the receiving region 14c for receiving a material to be mixed. The receiving region 14c has a cylindrical shape. The receiving region 14c of the mixing container 12c comprises a bulge 42c that is located outside a mixing zone of the mixer shafts 26c. The bulge 42c is embodied by a circle-portion cylindrical bulge. Principally however, for example, a rectangular embodiment of the bulge 42 would also be conceivable. The bulge 42c extends over an entire length of the mixing container 12c. The bulge 42c abuts on an end wall 24c of the mixing container 12c. The bulge 42c is arranged below the rotary axes 32c, 34c of the mixer shafts 26c. On an underside of the bulge 42c a discharge opening 74c of the mixing device 10c is arranged.

Furthermore, the lump breaker unit 18c is configured, during operation of the mixing device 10c, for a comminution of clumpings that have occurred in the material to be mixed. The lump breaker unit 18c is arranged in a frontal region 22c of the mixing container 12c. The lump breaker unit 18c is arranged, on a side of the receiving region 14c that is situated opposite the bearing point of the mixing unit 16c, in a frontal region 22c of the mixing container 12c. The lump breaker unit 18c is arranged in the end wall 24c of the mixing container 12c. The lump breaker unit 18c comprises at least one cutter element 20c protruding into the mixing container 12c. The lump breaker unit 18c comprises a plurality of cutter elements 20c protruding into the mixing container 12c. The cutter elements 20c have a shared shaft 64c, which protrudes through the end wall 24c. In the end wall 24c a bearing for the shaft 64c is accommodated. On an outer side of the end wall 24c a drive unit 68c of the lump breaker unit 18c is arranged, which is configured for driving the cutter elements 20c during operation. The drive unit 68c drives the shaft 64c of the cutter elements 20c rotationally. The shaft 64c of the cutter elements 20c is supported in a two-sided manner. The shaft 64c of the cutter elements 20c is supported on both end walls 24c, 52c of the mixing container 12c. A rotary axis 30c of the cutter elements 20c of the lump breaker unit 18c extends substantially in parallel to the rotary axes 32c, 34c of the mixer shafts 26c of the mixing unit 16c. The rotary axis 30c of the cutter elements 20c of the lump breaker unit 18c is arranged offset to the rotary axes 32c, 34c of the mixer shafts 26c. Furthermore the cutter elements 20c of the lump breaker unit 18c are partially arranged between the two mixer shafts 26c of the mixing unit 16c. The cutter elements 20c are arranged substantially outside the mixing zones of the mixer shafts 26c. The cutter elements 20c are arranged substantially inside the bulge 42c.

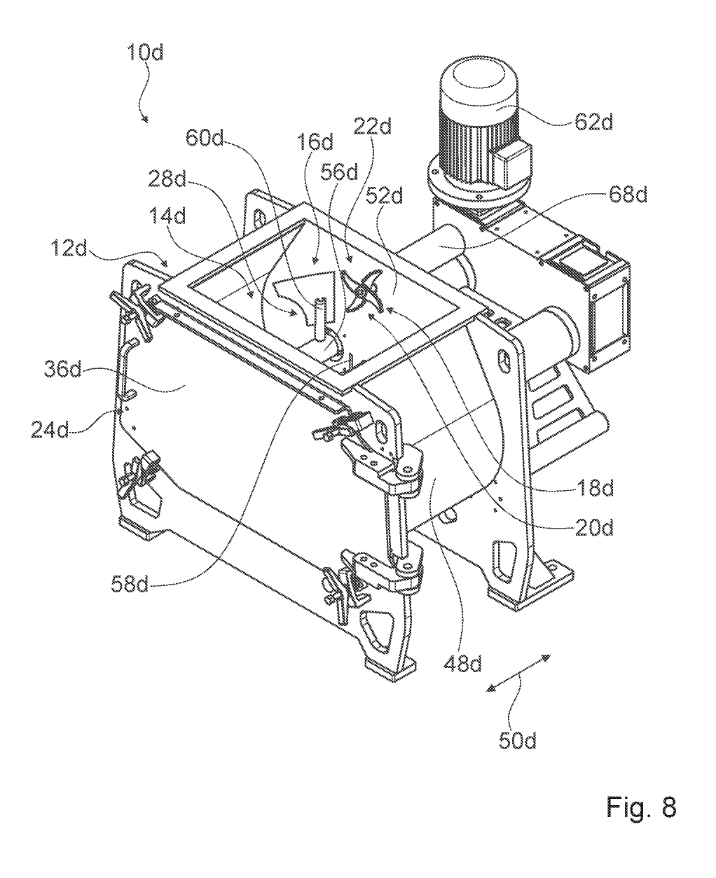

FIG. 8 shows a mixing device 10d with a mixing container 12d, with a mixing unit 16d and with a lump breaker unit 18d. The mixing unit 16d is configured for mixing a material to be mixed that is present in the mixing container 12d. The mixing unit 16d is implemented by a shaft-mixing unit. The mixing unit 16d comprises two mixer shafts 28d. The mixer shafts 28d extend substantially in parallel to one another. The two mixer shafts 28d of the mixing unit 16d comprise rotary axes 32d, 34d running in parallel. The mixer shafts 28d are each configured of a shaft 56d as well as of a plurality of mixing elements 60d, which are arranged on a circumference of the shaft 56d. The shafts 56d of the mixer shafts 28d protrude at one end through an end wall 52d of the mixing container 12d, out of a receiving region 14d, where they are driven by a drive unit 62d. The drive unit 62d drives the two mixer shafts 28d via a gearing that is not shown. The drive unit 62d drives the two mixer shafts 28d rotationally.

The lump breaker unit 18d is moreover configured, during operation of the mixing device 10d, for a comminution of clumpings that have occurred in the material to be mixed. The lump breaker unit 18d is arranged in a frontal region 22d of the mixing container 12d. The lump breaker unit 18d is arranged, on a side of the receiving region 14d that faces towards the bearing point of the mixing unit 16d, in a frontal region 22d of the mixing container 12d. The lump breaker unit 18d is arranged in the end wall 52d of the mixing container 12d, in which end wall 52d the mixing unit 16d is also borne. The lump breaker unit 18d comprises a cutter element 20d protruding into the mixing container 12d. A rotary axis of the cutter element 20d of the lump breaker unit 18d extends substantially in parallel to the rotary axes of the mixer shafts 28d of the one-sidedly supported mixing unit 16d. The rotary axis of the cutter element 20d of the lump breaker unit 18d is arranged offset to the rotary axes of the mixer shafts 28d. The cutter element 20d of the lump breaker unit 18d is partially arranged between the two mixer shafts 28d of the mixing unit 16d.

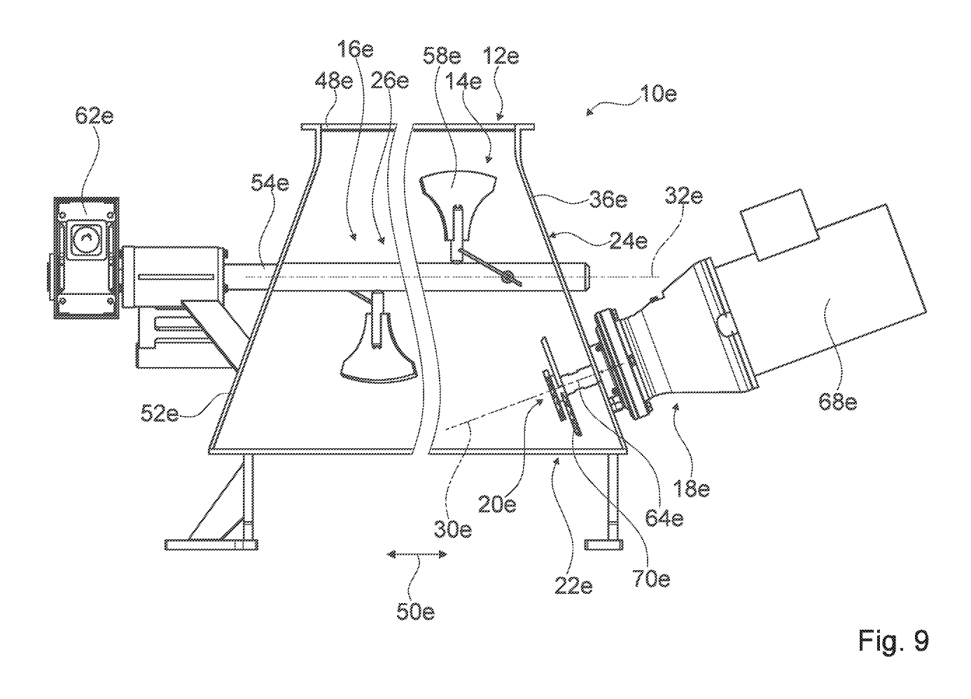

FIG. 9 shows a mixing device 10e with a mixing container 12e, with a two-sidedly supported mixing unit 16e and with a lump breaker unit 18e. The mixing device 10e is implemented by a continuous bulk material mixing device. The two-sidedly supported mixing unit 16e is configured for mixing a material to be mixed that is present in the mixing container 12e. The mixing unit 16e is implemented by a shaft-mixing unit. The mixing unit 16e comprises a mixer shaft 26e. Principally it would however also be conceivable that the mixing unit 16e comprises, for example, two mixer shafts 26e. The mixer shaft 26e of the mixing unit 16e comprises a rotary axis 32e. The rotary axis 32e runs in parallel to a main extension direction 50e of the mixing container 12e. The mixer shaft 26e protrudes through an entire receiving region 14e along the main extension direction 50e of the mixing container 12e. The mixer shaft 26e is supported on both ends.

The mixing container 12e has a substantially cylindrical basis shape. During operation a main extension direction 50e of the mixing container 12e extends substantially horizontally. The mixing container 12e furthermore implements a housing of the mixing device 10e. The mixing container 12e comprises an outer sleeve 48e. The mixing container 12e also comprises the receiving region 14e for receiving a material to be mixed. The receiving region 14e has a substantially cylindrical shape. The receiving region 14e is partly delimited by the outer sleeve 48e of the mixing container 12e. The receiving region 14e is delimited on an encompassing surface by the outer sleeve 48e of the mixing container 12e. The mixing container 12e further comprises two end walls 24e, 52e. The end walls 24e, 52e close the mixing container 12e on two opposite ends of the outer sleeve 48e. The end walls 24e, 52e delimit the receiving region 14e on opposite ends along a middle axis of the receiving region 14e. The end walls 24e, 52e respectively run perpendicularly to the middle axis of the receiving region 14e. The end walls 24e, 52e are respectively inclined with respect to the rotary axis 32e of the mixer shaft 26e by a smallest angle of 70°. Principally however a different angle conceivable which is deemed expedient by someone skilled in the art. The end walls 24e, 52e are inclined away from one another on one side. The end walls 24e, 52e taper towards one another conically towards a top. The end walls 24e, 52e are respectively inclined to one another by 40°.

Furthermore the lump breaker unit 18e is configured, during operation of the mixing device 10e, for a comminution of clumpings that have occurred in the material to be mixed. The lump breaker unit 18e is arranged in a frontal region 22e of the mixing container 12e. The lump breaker unit 18e is arranged, on a side of the receiving region 14e that is situated opposite a bearing point of the mixing unit 16e, in a frontal region 22e of the mixing container 12e. The lump breaker unit 18e is arranged in an end wall 24e of the mixing container 12e. The lump breaker unit 18e comprises a cutter element 20e protruding into the mixing container 12e. The cutter element 20e comprises a shaft 64e, which protrudes through the end wall 24e. In the end wall 24e a bearing for the shaft 64e is accommodated. On an outer side of the end wall 24e, a drive unit 68e of the lump breaker unit 18e is arranged, which is configured to drive the cutter element 20e during operation. The drive unit 68e drives the shaft 64e of the cutter element 20e rotationally. A rotary axis 30e of the cutter element 20e of the lump breaker unit 18e extends substantially in parallel to the rotary axis 32e of the mixer shaft 26e of the mixing unit 16e. The rotary axis 30e of the cutter element 20e of the lump breaker unit 18e is inclined with respect to the rotary axis 32e of the mixer shaft 26e of the mixing unit 16e by at least 5°. The rotary axis 30e of the cutter element 20e of the lump breaker unit 18e is inclined with respect to the rotary axis 32e of the mixer shaft 26e of the mixing unit 16e by at least 15°. The rotary axis 30e of the cutter element 20e of the lump breaker unit 18e is inclined with respect to the rotary axis 32e of the mixer shaft 26e of the mixing unit 16e by no more than 30°. The rotary axis 30e of the cutter element 20e of the lump breaker unit 18e is inclined with respect to the rotary axis 32e of the mixer shaft 26e of the mixing unit 16e by 20°.

1. A mixing device, in particular bulk material mixing device, with at least one mixing container comprising a receiving region for receiving a material to be mixed, with at least one mixing unit which is configured for mixing the material to be mixed that is present in the mixing container, and with at least one lump breaker unit comprising at least one cutter element which protrudes into the mixing container, wherein
the at least one lump breaker unit is arranged in a frontal region of the mixing container.

2. The mixing device according to claim 1, wherein
the at least one mixing unit is supported one-sidedly.

3. The mixing device according to claim 1, wherein
the at least one lump breaker unit is arranged in an end wall of the mixing container.

4. The mixing device according to claim 1, wherein
the at least one mixing unit comprises at least one mixer shaft.

5. The mixing device according to claim 4, wherein
a rotary axis of the cutter element of the at least one lump breaker unit extends at least substantially in parallel to a rotary axis of the at least one mixer shaft of the one-sidedly supported mixing unit.

6. The mixing device according to claim 1, wherein
the mixing container comprises, in a region of an end wall, a pivot door, in which the at least one lump breaker unit is arranged.

7. The mixing device according to claim 1, wherein
the at least one mixing unit comprises at least two mixer shafts extending substantially in parallel to each other.

8. The mixing device according to claim 7, wherein
the at least one cutter element of the lump breaker unit is arranged at least partly between the at least two mixer shafts of the at least one mixing unit.

9. The mixing device according to claim 4, wherein
the at least one cutter element of the lump breaker unit intersects with a rotary axis of the mixer shaft of the at least one mixing unit.

10. The mixing device according to claim 1, wherein
the receiving region of the at least one mixing container comprises at least one bulge which is located outside a mixing zone of the at least one mixer shaft and into which the at least one cutter element of the lump breaker unit protrudes.

11. The mixing device according to claim 1, wherein
viewed in a plane that is perpendicular to a rotary axis of the at least one cutter element, the at least one cutter element of the lump breaker unit comprises a cutter impact surface, the area value of which amounts to at least 2% of an area value of a wall surface of an end wall of the mixing container.

12. A method for operating a mixing device according to claim 1, wherein
in at least one first method step a material to be mixed is transported to a cutter element of at least one lump breaker unit of the mixing device by means of a mixer shaft of a mixing unit of the mixing device.

13. The method according to claim 12, wherein
in at least one further method step a material to be mixed is transported away from the cutter element of the at least one lump breaker unit by means of a mixer shaft of the mixing unit of the mixing device.
